(19) United States
(12) Patent Application Publication
(10) Pub. No.: US 2006/0199161 A1
(43) Pub. Date: Sep. 7, 2006

(54) Method of creating multi-lingual lyrics slides video show for sing along

(76) Inventor: Sung F. Huang, Irvine, CA (US)

Correspondence Address: Sung F. Huang, 14 Pismo Beach, Irvine, CA, 92602, US

(21) Appl. No.: 11/069,182

(22) Filed: Mar. 1, 2005

(51) Int. Cl. G09B 5/00

(52) U.S. Cl. 434/307 A

(57) ABSTRACT

The invention discloses a system and methods for slides video shows on a DVD with the song and lyrics played and displayed synchronized together on a monitor.

### FIELD OF THE IMVENTION

The present invention generally relates to a system for creating a sing-along slide video show with music and images, more particularly, to a system and methods for a slide video show on a DVD with the song and lyrics played and displayed in a synchronized manner on a displaying instrument of a TV monitor or a projecting screen.

### BACKGROUND OF THE INVENTION

A wide variety of systems have been developed for the song and lyrics to be sung along by the amateur song lovers or used in professional singing occasions. Theses systems generally pre-record the song's music in its orchestrate forms without the vocals, together with the song's lyrics saved in the same media by predetermining the timing of the beginning and the ending of each lyric. The song and lyrics are played and displayed simultaneously on a computer, a TV monitor, or the like, enabling the song lovers to read the lyrics and sing along with the song.

For the most part, these systems have involved the use of playback equipment, in order for a person to make use of these prior art systems. New player equipment or instrument, for examples, a CD player with Graphics Capabilities or a Karaoke Sing-Along Machine, must be purchased, along with specially recorded media which is generally not compatible with the common playback equipment. When using a CD player without graphics capability, only the music portion would be heard. Other prior arts creating a still slide with pages of song lyrics projecting on the screen, audience must watch the entire lyrics page to sing along with the music; generally it is inconvenient and can easily get lost to the song.

Karaoke which means “empty orchestra” is an increasingly popular form of entertainment where music is played while accompanied with a display of the song lyrics so that a Karaoke performer can sing along. Various techniques are used to cue the performer to the timing of the lyrics. One commonly used technique is a yellow fill wherein the letters of the words of the song appearing on the display, initially white, change to yellow at the appropriate time. Another method involves a bouncing ball which bounces on each word of the phrase to be sung. However, whatever technique is utilized, the creation of properly timed cues is a time consuming, labor intensive task which generally requires a substantial amount of experience to become proficient.

Karaoke is a musical performance method in which a person (i.e., the singer) performs a musical show by singing along with a pre-recorded song through the reading of that particular song's lyrics, which are preferably displayed on a display device, such as, for example, a television screen situated within view of the singer. In one embodiment, the singer's voice overrides the voice of the original singer of the pre-recorded song. A video motion picture, often referred to as a music video, may also be displayed as an accompaniment to both the music and the singer. Devices providing this opportunity are known as karaoke musical reproduction devices, and will be referred to as karaoke devices. Current karaoke devices use tapes, compact disks (CDs), digital videodisks (DVDs), computer disks, video compact disks (VCDs) or any other type of electronic medium to record and play both the music and the lyrics.

U.S. Pat. No. 6,537,078, entire contents of which are incorporated herein by reference, discloses a karaoke-type entertainment center that includes a system and apparatus for transmitting and displaying music audio, text and videos for users to sing along with a karaoke or act at an entertainment stage area within an individual karaoke player room. It further discloses providing a karaoke-type entertainment center for inspiring musicians or actors to video tape themselves and their group where the video tape can be used as an audition tape, as the entertainment center is less expensive than a recording studio.

U.S. Pat. No. 5,648,628, entire contents of which are incorporated herein by reference, discloses a karaoke system which features, as its storage medium of musical data, a removable solid state memory cartridge. Lyrics accompanying the selectable musical rendition are presented on a liquid crystal display. The solid state memory cartridge used in place of the disk drive and the liquid crystal display used in place of the video display ensures low power consumption compared to present state of the art Karaoke systems so that the Karaoke system of the '628 patent is battery operated and therefore can be housed in a portable configuration.

U.S. Pat. No. 5,440,677, entire contents of which are incorporated herein by reference, discloses a system and method which is for use as an authoring system for the development of CD-ROM products containing interleaved digitized audio and graphic images and other information which may be read and displayed or played under control of a computer. By use of the invention, the graphic images and other computer information are stored in a file on the CD-ROM such that when the CD-ROM is accessed by a user, the graphic images and other computer information are displayed and made available to the user synchronously with the playing of the audio information.

U.S. Pat. No. 6,062,868, entire contents of which are incorporated herein by reference, discloses a sing-along data transmitting method which comprises: providing a sing-along data center for supplying background video data and music data; providing a plurality of sing-along data receiving terminals for receiving the background video data and music data fed from the sing-along data center; transmitting a plurality of background video data by way of a plurality of different channels; and transmitting music data of a plurality of melodies by way of at least one channel.

U.S. Pat. No. 5,649,234, entire contents of which are incorporated herein by reference, discloses method and apparatus for simplifying the steps needed to produce a graphical cue to words being displayed as they are to be sung by a performer such as in Karaoke. The '234 patent provides a system which facilitates the production of a CD-Graphics (CD-G) product containing compact disc (“CD”) audio accompanied with a visual presentation of the lyrics.

U.S. Pat. No. 5,574,239, entire contents of which are incorporated herein by reference, discloses a method of displaying a title and lyrics of the first measure of a reserved song before the end of a currently performed song includes steps for calculating remaining time by comparing total performance time with an elapsed time of a currently performed song, obtaining a title and lyrics information for the first measure of the reserved song responsive to a reserved song number when the remaining time is less than a predetermined value, and displaying the title and the lyrics information superimposed on a background image associated with the currently performed song.

What is desirable is an apparatus and methods for creating a sing-along music and image slides video show on a DVD, VCD or the same, with the song and lyrics being played and displayed in a synchronized manner on a TV monitor, on a projecting screen, or other monitors. The song lovers (the audiences) can view the lyrics in a short verse with large font and sing along with the music by using a convenient DVD or VCD player connected to their television in absence of a karaoke sing-along machine.

### SUMMARY

The present invention provides an apparatus and methods for creating a sing-along music and image video show with one or multi-national language lyrics displaying on a TV monitor or on a projecting screen. The synchronized music and lyrics are played on the screen. The audiences from different nations are able to view the lyrics and sing along the song with their own languages that are displayed on the TV, projecting screen, or other monitors.

The present invention also provides a system and methods to create a DVD or VCD for the song listeners from different nations to watch and choose their own language lyrics to sing along with the music in a concert, in church assembly or even in their own home by using a commercially available DVD or VCD player connected to the television.

Some aspects of the invention relate to a system for a musical and video sing-along DVD, comprising a plurality of slides embedded with background music, wherein each slide has images and synchronized lyrics, each slide being given a time code for displaying the slide and playing the lyrics within the predetermined time. In a further embodiment, the lyrics are displayed in at least one language.

Some aspects of the invention relate to a method of playing a sing-along musical and video DVD, comprising: providing a DVD that comprises a series of still digital slides or video image slides in a numerical sequence, wherein each slide contains a verse or phrase of a song's lyrics in at least one language, and wherein each slide is encoded with a predetermined singing time of the verse or phrase; placing the DVD in a computer; starting the DVD in the computer, the computer detecting the encoded singing time on each of the slides; and displaying the slides on a monitor one at a time for playing the sing-along DVD.

Some aspects of the invention relate to a method of creating a sing-along DVD, comprising: providing a DVD with a series of slides, each slide is accompanied with graphic images, a song, a song's lyrics (in at least one language), and a time code for each slide; synchronizing the lyrics with the song; rendering the slides into a video show; and burning into a playable DVD.

### BRIEF DESCRIPTION OF THE DRAWINGS

Additional objects and features of the present invention will become more apparent and the invention itself will be best understood from the following Detailed Description of Exemplary Embodiments, when read with reference to the accompanying drawings.

FIG. 1 shows a display of the slide video show on a TV or a projecting screen.

FIG. 2 shows the steps of (A) creating a multi-lingual musical and video show with one slide at a time, and (B) playing back the show on a TV or projecting screen.

FIG. 3 shows sample slides of multi-lingual lyrics in a sing-along song video system.

### DETAILED DESCRIPTION OF EXEXMPLARY EMBODIMENTS

The following detailed description is of the best presently contemplated modes of carrying out the invention. This description is not to be taken in a limiting sense, but is made merely for the purpose of illustrating general principles of embodiments of the invention.

By compiling a series of still digital slides or digital video images in a numerical sequence, each slide contains a verse or phrase of a song's lyrics in at least one language, for example, one, two, three, or more languages. The single language or multi-lingual lyrics are keyed in or stored and displayed on about the top and/or bottom lines of the slides. In one embodiment, the lyrics are displayed on the slide that do not block or substantially block the images. Each slide is also marked down a code with the necessary singing time of the lyrics verse, whereby the computer digitally saves this complete set of the slides as graphic images. In one embodiment, the graphic images are derived from stored data or from a video camera. In play back of the graphic images set, the computer detected the marked timing of each slide and displays the slide on a monitor or TV screen with the same length of time marked. In one embodiment, the system uses “DVD Authoring Program” that supports slideshows, the above graphic images set could be easily rendered and produced into a video show.

DVD Authoring Program is the process of collecting audio, video, menus, subtitles, etc. into an interactive branching structure that will eventually become a playable DVD. There are several software programs provided by companies such as Sonic Solutions, Apple, Ulead, Pinnacle, and others. The DVD authoring program is well known to one of ordinary skill in the art.

In the same graphic image set, the same song or choir music is saved as the background for the above sing-along slides video show. In play back of this song-embedded slides video show, the computer detects the code-marked timing of each slide, displays the lyrics and images on the screen with the song played in a loudspeaker simultaneously, whereby the background music and the lyrics are synchronized until the end of the song. Some aspects of the invention render the music and graphic images slides show into a video by the “DVD Authoring Program”. A playable DVD or VCD could be easily burned and created from the same computer's DVD-ROM drives.

Using a commercially available DVD/VCD player that is connected to a television or a computer projector, the audiences from different countries or nations who listen and watch the multi-lingual lyrics music & image video show are able to watch, listen and pick up their own language lyrics to sing along with the song.

In some aspects of the invention, a non sing-along system with images, caption in one or more various language(s) typed on and saved on these same slides system, with the embedded audio Speech, Caption synchronized presentation, rendered into a video, is able to show-and-tell the products, services or other information tailoring to the specific needs of people from a particular nation or nations, with a single created DVD, without the human speaker repeatedly telling the same speech, after a MicroSoft Power-Point slides show.

Some aspects of the invention relate to a non sing-along video DVD system, comprising a plurality of slides embedded with an audio speech, wherein each slide has the audio speech and synchronized caption, wherein the caption is shown in at least one language enabling show-and-tell products, services or information tailoring to specific needs of people from a particular nation or nations. In a further embodiment, each slide being given a time code for displaying and playing the slide within the predetermined time for playing a portion of the audio speech with the synchronized caption. In a further embodiment, the slides are created by using a DVD authoring program that supports a slideshow.

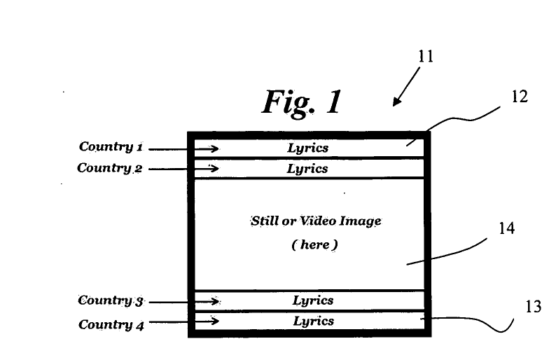

FIG. 1 shows a display 11 of the sing-along slide video show on a TV or a projecting screen. In one embodiment, the display shows a first lyrics 12 in one language at the top portion of the slide and a second lyric in another language at the bottom portion of the slide. Some aspects of the invention provide the lyrics as shown at a top portion or a bottom portion of the slides such that the lyrics do not block or substantially block the image 14 of a still or video image style. In one embodiment, the lyrics that are displayed at that time thereby display the lyrics in real time and are in synchronization with the background music as it is being played.

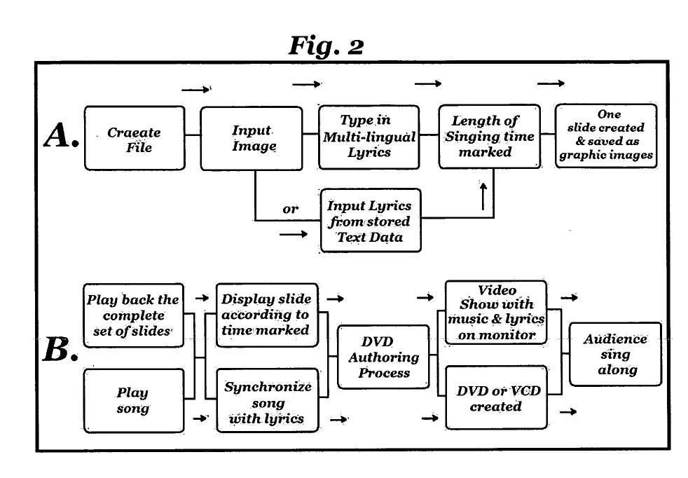

FIG. 2 shows the steps of creating a multi-lingual musical and video show with one slide at a time. The steps for creating a slide may include, but not limited to, (a) file creation, (b) image input, (c) multi-lingual lyrics typed or keyed in, (d) length of singing time marked, and (e) a slide created and saved as graphic images. In an alternate embodiment, the multi-lingual lyrics step may come from stored text data. Some aspects of the invention relate to a method of creating a sing-along DVD, comprising: providing a DVD with a series of slides, each slide is accompanied with graphic images, a song, a song's lyrics, and a time code for each slide; synchronizing the lyrics with the song; rendering the slides into a video show; and burning into a playable DVD.

FIG. 2 further shows steps for playing back the show on a TV or a projecting screen. The steps may include, but not limited to, (a) playing back the complete set of slides and/or playing a song, (b) displaying slides according to time marked and/or synchronizing the song with lyrics, (c) applying a DVD authoring process for creating a DVD or VCD, (d) running a video show with music and lyrics on a monitor, and (e) audience singing along. Some aspects of the invention relate to a method of playing a sing-along musical and video DVD, comprising: providing a DVD that comprises a series of still digital slides or video image slides in a numerical sequence, wherein each slide contains a verse or phrase of a song's lyrics in one language or multiple-national languages, and wherein each slide is encoded with a predetermined singing time of the verse or phrase; placing the DVD in a computer; in playing the slides in the DVD, the computer detecting the encoded singing time on the slide and displaying the slide on a computer or TV monitor; and playing the DVD.

In an alternate embodiment, it is provided a method of playing a sing-along musical and video DVD, comprising: providing a DVD that comprises a series of still digital slides or video image slides in a numerical sequence, wherein each slide contains a verse or phrase of a song's lyrics in at least one language, and wherein each slide is encoded with a predetermined singing time of the verse or phrase; placing the DVD in a computer; starting the DVD in the computer, the computer detecting the encoded singing time on each of the slides; and displaying the slides on a monitor one at a time for playing the sing-along DVD.

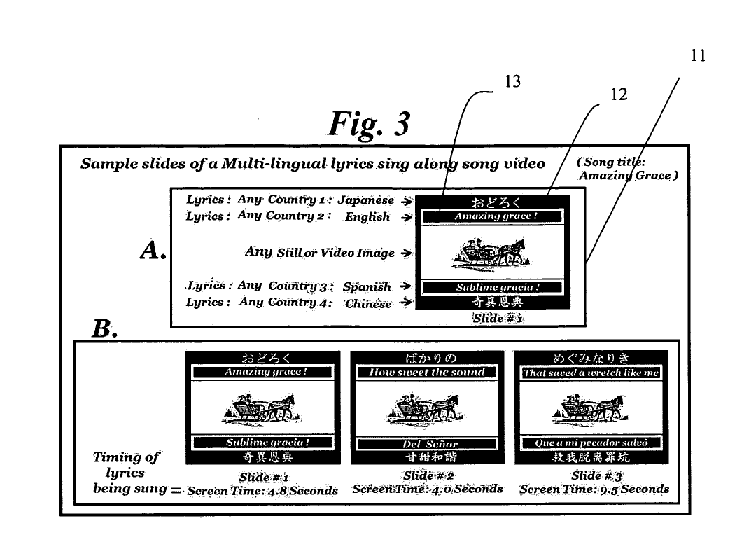

FIG. 3 shows several sample slides of multi-lingual lyrics in a sing-along song video system. Some aspects of the invention relate to a system for a musical and video sing-along DVD, comprising a plurality of slides embedded with background music, wherein each slide has images and synchronized lyrics, each slide being given a time code for displaying and playing the slide within the predetermined time.

FIG. 3 further shows 3 sample slides for each of three sing-along songs. The slide #1 lyrics “Amazing grace” has 4 different countries languages (that is, Japanese, English, Spanish and Chinese) marked with 4.8 seconds for singing and displaying time for one of the slides in “Amazing grace”. The slide#2 lyrics “How sweet the sound” in multiple-languages marked with 4.0 seconds for singing and displaying time for one of the sides in “How sweet the sound”. The slide #3 lyrics “That saved a wretch like me” marked with 9.5 seconds for singing and displaying time for one of the slides in “That saved a wretch like me”. By way of illustration, the entire Amazing Grace song with all slides may last about 3 minutes for displaying and playing.

From the foregoing description, it should now be appreciated that a system and methods for a sing-along slide video show on a DVD with the song and lyrics played and displayed in a synchronized manner on a displaying instrument of a TV monitor or a projecting screen have been disclosed. While the invention has been described with reference to a specific embodiment, the description is illustrative of the invention and is not to be construed as limiting the invention. Various modifications and applications may occur to those who are skilled in the art, without departing from the true spirit and scope of the invention.

1. A system for a sing-along musical and video DVD, comprising a plurality of distinct slides embedded with background music, wherein each and every individual slide has images and synchronized lyrics, each slide being given a time code for displaying and playing said slide within the predetermined time.

2. (canceled)

3. The system of claim 2, wherein the images comprise graphic images from a video camera.

4-8. (canceled)

9. A method of playing a sing-along musical and video DVD, comprising:
providing a DVD that comprises a series of still digital slides or distinct video image slides in a numerical sequence, wherein each and every individual slide contains a verse or phrase of a song's lyrics in at least one language, and wherein each slide is encoded with a predetermined singing time of said verse or phrase;
placing said DVD in a computer;
starting said DVD in the computer, the computer detecting the encoded singing time on each of the slides; and
displaying said slides on a monitor one at a time for playing the sing-along DVD.

10-20. (canceled)
